(19) United States
(12) Patent Application Publication
(10) Pub. No.: US 2009/0080560 A1
(43) Pub. Date: Mar. 26, 2009

(54) CLOSED-LOOP BEAMFORMING WEIGHT ESTIMATION IN FREQUENCY DIVISION DUPLEX SYSTEMS

(75) Inventors: Yanxin Na, Plano, TX (US); Hang Jin, Plano, TX (US)

Correspondence Address: EDELL, SHAPIRO & FINNAN, LLC, 1901 RESEARCH BOULEVARD, SUITE 400, ROCKVILLE, MD, 20850, US

(73) Assignee: CISCO TECHNOLOGY, INC., San Jose, CA (US)

(21) Appl. No.: 12/204,872

(22) Filed: Sep. 5, 2008

Related U.S. Application Data
(60) Provisional application No. 60/974,007, filed on Sep. 20, 2007.

(51) Int. Cl. H04B 7/02

(52) U.S. Cl. 375/267

(57) ABSTRACT

A closed-loop beamforming weight estimation process in which, at a first device, respective ones of a plurality of beamforming weight vectors are applied to subcarriers associated with a pattern of subcarriers assigned to a corresponding subcarrier stream such that the plurality of subcarriers assigned to a subcarrier stream is weighted by a corresponding one of the plurality of beamforming weight vectors to produce a plurality of beamformed streams transmitted from a plurality of antennas of the first device to a second device. The second device estimates and analyzes the channel information for each of the received beamformed streams to identify at least one of the beamformed streams that is preferred over the others. The second device transmits to the first device a feedback signal that contains information identifying the preferred beamformed stream. The first device computes a plurality of new beamforming weight vectors based on the information identifying the preferred beamformed stream. The first device applies the new beamforming weight vectors to streams of subcarriers to repeat the process until system parameters or conditions are met.

### CROSS-REFERENCE TO RELATED APPLICATIONS

This application claims priority to U.S. Provisional Patent Application No. 60/974,007, filed Sep. 20, 2007, the entirety of which is incorporated herein by reference.

### TECHNICAL FIELD

The present disclosure generally relates to estimating beamforming weights for use in wireless communication systems.

### BACKGROUND

In wireless communication systems, antenna arrays are used at devices on one or both ends of a communication link to suppress multipath fading and interference and to increase system capacity by supporting multiple co-channel users and/or higher data rate transmission. In order to achieve these gains, the antenna elements in an antenna array are weighted with corresponding elements of a vector, called a beamforming weight vector or a spatial signature.

There are challenges in computing the proper beamforming weight vector. For example, the estimation of the beamforming weight vector can be computationally intensive. Consequently, as the number of antenna elements at one or both devices on a communication link is increased, computing the beamforming weight vector becomes even more intensive.

In a frequency division duplex (FDD) wireless communication system, a base station (BS) may be equipped with an antenna array to improve downlink transmission performance. However, improving downlink performance using an antenna array is usually a more difficult problem than the associated uplink transmission performance due to lack of information of estimated downlink channel coefficients. It is known that the downlink channel covariance matrices can be used to determine the downlink beamforming weights. The uplink channel covariance matrices cannot alone be used to improve the performance in predicting beamforming weights for some communication channel conditions.

What is needed is a low complexity and low overhead approach that can significantly improve the process of downlink beamforming in FDD systems.

### BRIEF DESCRIPTION OF THE DRAWINGS

FIG. 1 is a block diagram showing an example of a wireless communication system in which first and second communication devices cooperate to perform a closed-loop beamforming weight estimation process.

FIG. 2 is a block diagram of the first communication device, e.g., a base station that is configured to perform a beamforming weight generation process as part of the closed-loop beamforming weight estimation process.

FIG. 3 is a block diagram of the second communication device, e.g., a mobile station that is configured to perform a feedback process as part of the closed-loop beamforming weight estimation process.

FIGS. 4A and 4B illustrate an example of a flow chart depicting the beamforming weight generation process.

FIG. 5 is a diagram depicting an example of how beamforming weight vectors are applied to subcarriers at the first communication device.

FIG. 6 is an example of a flow chart depicting the feedback process.

### DESCRIPTION OF EXAMPLE EMBODIMENTS

Overview

A closed-loop beamforming weight estimation process in which, at a first device, respective ones of a plurality of beamforming weight vectors are applied to subcarriers associated with a pattern of subcarriers assigned to a corresponding subcarrier stream such that the plurality of subcarriers assigned to a subcarrier stream is weighted by a corresponding one of the plurality of beamforming weight vectors to produce a plurality of beamformed streams transmitted from a plurality of antennas of the first device to a second device. The second device estimates and analyzes the channel information for each of the received beamformed streams to identify at least one of the beamformed streams that is preferred over the others. The second device transmits to the first device a feedback signal that contains information identifying the preferred beamformed stream. The first device computes a plurality of new beamforming weight vectors based on the information identifying the preferred beamformed stream. The first device applies the new beamforming weight vectors to streams of subcarriers to repeat the process until system parameters or conditions are met.

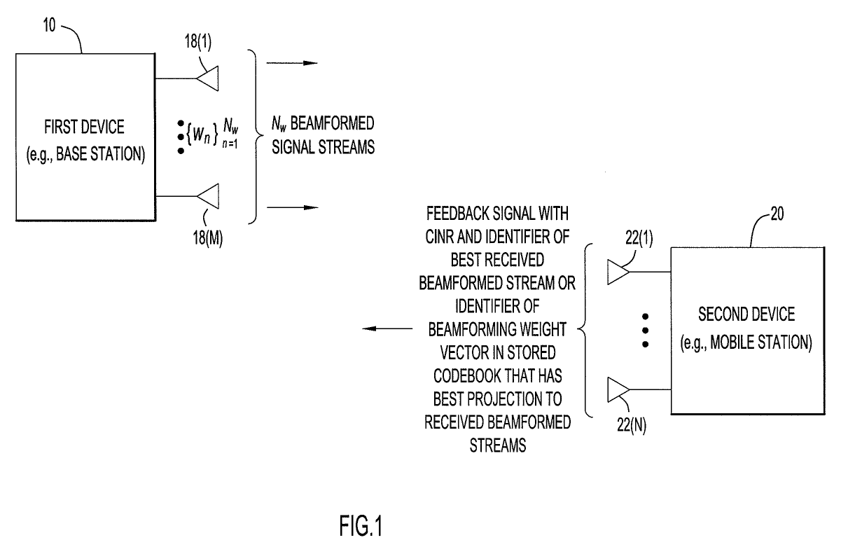

Referring first to FIG. 1, a wireless radio communication system or network is shown generally at reference numeral 5 and comprises a first communication device 10, e.g., a base station (BS), and a second communication device 20, e.g., a mobile station (MS). The BS 10 may connect to other wired data network facilities (not shown) and in that sense serves as a gateway or access point through which one or more MS's have access to those data network facilities.

The BS 10 comprises a plurality of antennas 18(1)-18(M) and the MS 20 comprises a plurality of antennas 22(1)-22(N). The BS 10 may wirelessly communicate with the MS 20 using a wideband wireless communication protocol in which the bandwidth is much larger than the coherent frequency bandwidth. An example of such a wireless communication protocol is the IEEE 802.16 communication standard, also known commercially as WiMAX™. Another example of a wireless communication protocols is the IEEE 802.11 communication standard, also know commercially as WiFi™.

When the devices 10 and 20 operate according to FDD wireless communication techniques, the BS 10 transmits signals in one or more frequency channels that are different from those used by the MS 20 when transmitting to the BS 10. A close-loop method is provided herein to allow the BS 10 to set beamforming weight vectors used for transmitting one or several signal streams to the MS 20. Briefly, based on uplink channel information and feedback information received from the MS 20, the BS 10 repeatedly (or only once) sends a plurality of “predicted” beamformed (pilot) streams to the MS 20 using a set of beamforming weight vectors {wₙ}ₙ₌₁^{N}^{_{w}}. The MS 20 selects or identifies at least one of the received beamformed streams (e.g., by selecting an index of received beamformed stream or uses a codebook to select an index of beamforming weights in the codebook that have the best projection to the received beamformed streams). The MS 20 transmits a signal, called a feedback signal, which contains an identifier of the best received beamformed stream or streams, either by way of an index or indices of the selected beamformed stream(s) or by an index or indices of the beamforming weight vector in the codebook that has the best projection to the received beamformed streams. The MS also transmits carrier to interference plus noise ratio (CINR) information in the feedback signal. The BS 10 generates a new set of beamformed weight vectors and transmits new beamformed streams to the MS 20 until the CINR contained in a feedback signal from the BS 10 is greater than a threshold value or after a maximum number of loops or iterations are performed.

FIG. 1 illustrates a single MS, but it should be understood that there are multiple MS's and multiple BS's in system 5. The BS 10 performs the closed-loop beamforming weight estimation process described herein with respect to each MS with which it communicates.

In the following description, the downlink beamforming weight vectors are generated in an FDD orthogonal frequency division multiple access (OFDMA) system as an example. However, it is understood that these techniques may be extended to process beamforming weights in any FDD wireless communication system. The techniques described herein present an approach with low complexity and low overhead that can significantly improve the process of downlink beamforming in macrocell/microcell FDD systems.

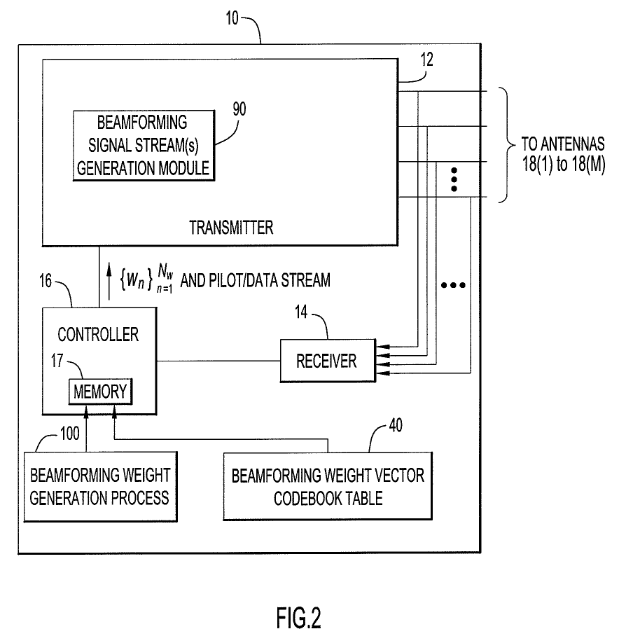

Turning to FIG. 2, an example of a block diagram is shown of the BS 10 that is configured to perform the BS side of the closed-loop techniques described herein. The BS 10 comprises a transmitter 12, a receiver 14 and a controller 16. The controller 16 supplies data to the transmitter 12 to be transmitted and processes signals received by the receiver 14. In addition, the controller 16 performs other transmit and receive control functionality. Part of the functions of the transmitter 12 and receiver 14 may be implemented in a modem and other parts of the transmitter 12 and receiver 14 may be implemented in radio transmitter and radio transceiver circuits. It should be understood that there are analog-to-digital converters (ADCs) and digital-to-analog converters (DACs) in the various signal paths to convert between analog and digital signals.

The transmitter 12 may comprise individual transmitter circuits that supply respective upconverted signals to corresponding ones of a plurality of antennas 18(1)-18(M) for transmission. To this end, the transmitter 12 comprises a beamforming signal stream generation module 30 that, during execution of the closed-loop method, applies beamforming weight vectors {wₙ}ₙ₌₁^{N}^{_{w}} to a plurality of pilot/data streams to be transmitted via the antennas 18(1)-18(M). During normal transmission modes, the beamforming signal stream(s) generation module 30 applies one or more beamforming weight vectors (derived from execution of the closed-loop process) to transmit data from the BS 10 to the MS 20.

The receiver 14 receives the signals detected by each of the antennas and supplies corresponding antenna-specific receive signals to controller 16. It is understood that the receiver 14 may comprise a plurality of receiver circuits, each for a corresponding one of a plurality of antennas. For simplicity, these individual receiver circuits and individual transmitter circuits are not shown.

The controller 16 comprises a memory 17 or other data storage block that stores data used for the techniques described herein. The memory 17 may be separate or part of the controller 16. In addition, logic instructions for performing a beamforming weight generation process 100 may be stored in the memory 17 for execution by the controller 16. The process 100 generates the beamforming weights {wₙ}ₙ₌₁^{N}^{_{w}} that are supplied to the transmitter 12 for use by the beamforming signal stream(s) generation module 90 for use during the closed-loop beamforming estimation process and during normal transmission modes. The memory 17 may also store data for a codebook table 40 comprising values for each of a plurality of beamforming weight vectors, with an identifier, e.g., table index, for each beamforming weight vector.

The functions of the controller 16 may be implemented by logic encoded in one or more tangible media (e.g., embedded logic such as an application specific integrated circuit, digital signal processor instructions, software that is executed by a processor, etc.), wherein the memory 17 stores data used for the computations described herein (and/or to store software or processor instructions that are executed to carry out the computations described herein). Thus, the process 100 may be implemented with fixed logic or programmable logic (e.g., software/computer instructions executed by a processor). Moreover, the functions of the beamforming signal stream generation module 90 and the process 100 may be performed by the same logic component, e.g., the controller 16.

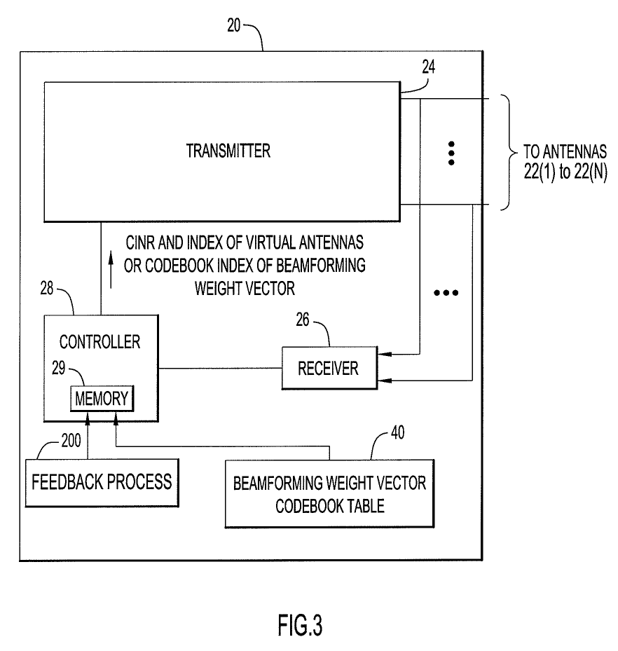

Turning to FIG. 3, an example of a block diagram of the MS 20 is shown. The MS 20 comprises a transmitter 24, a receiver 26 and a controller 28 in a similar configuration as that shown for the BS 10 in FIG. 2. The controller comprises a memory 29 that stores data and instructions. In particular, the controller 29 stores data for the beamforming weight vector codebook table 40 and instructions for a feedback process 200. The feedback process 200 cooperates with the beamforming weight generation process 100 in the BS 10 to perform the closed-loop beamforming weight estimation process.

As is evident from FIGS. 2 and 3, the BS 10 and the MS 20 store the same beamforming weight vector codebook table 40. This allows the MS 20 to assist in identifying candidate beamforming weight vectors that the BS 10 may use in computing the ultimate beamforming weight vector(s) for normal transmission modes to the MS 20. It should be understood that each of a plurality of MS's store the same codebook table 40 for use when executing the closed-loop beamforming weight estimation process between the BS 10 and respective ones of the plurality of other MS's.

Set forth below is an example of the codebook table 40 stored in the BS and MS's, where Z is the number of elements in one beamforming weight vector in the codebook.

| Index | Beamforming Weight Vector |
|---|---|
| 1 | \tilde{w}₁ = (b_{1,1}, b_{1,2}, b_{1,3}, . . . , b_{1,Z}) |
| 2 | \tilde{w}₂ = (b_{2,1}, b_{2,2}, b_{2,3}, . . . , b_{2,Z}) |
| . . . | |
| N_{codebook} | \tilde{w}_{Ncodebook} = (b_{Ncodebook,1}, |
| | b_{Ncodebook,2}, b_{Ncodebook,3}, . . . , b_{Ncodebook,Z}) |

Thus, codebook index “1” identifies the beamforming weight vector \tilde{w}₁=(b_{1,1}, b_{1,2}, b_{1,3}, . . . , b_{1,Z}), codebook index “2” identifies the beamforming weight vector \tilde{w}₂=(b_{2,1}, b_{2,2}, b_{2,3}, . . . , b_{2,Z}), and so on. Each beamforming weight vector has a dimension Z≦N_{w} corresponding to the number of virtual antennas of the BS. That is, each beamforming weight vector at the BS side is a 1×M vector, and each beamforming weight vector at the MS side is a 1×Z vector. Each of the weights (e.g., b_{1,1}, b_{1,2}, b_{1,3}, . . . , b_{1,Z} in the case of weight vector \tilde{w}₁) of the weight vectors are complex (magnitude and phase) values.

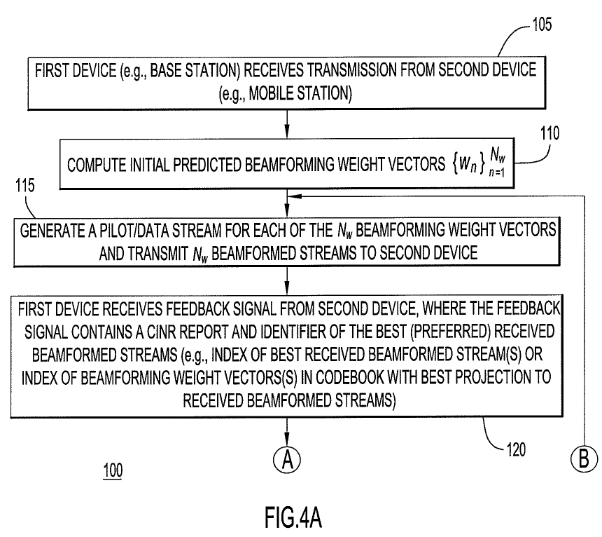

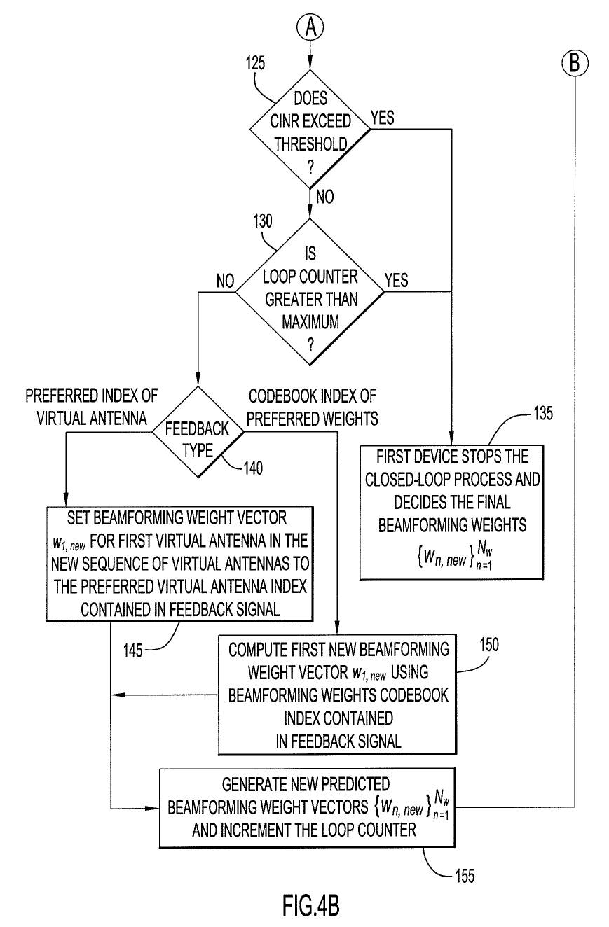

Turning now to FIGS. 4A and 4B, the beamforming weight generation process 100 executed in the BS 10 is now described. This closed-loop downlink beamforming weight estimation techniques described herein is applicable to any wireless communication system, such as in FDD code division multiple access (CDMA) systems and FDD OFDMA systems. This closed-loop downlink beamforming weight estimation techniques described herein involves generating the adaptive downlink beamforming weights with a combination of prediction computations and feedback information. Both the BS and MS may compute and adjust the beamforming weight vectors, though the final decision of the beamforming weight vectors to be used is made by the BS.

A covariance is computed for every MS with which a BS communicates, if every MS experiences a different channel. First, the channel coefficients of the uplink are estimated in the frequency domain for the desired user as H_{UL}=[H_{UL,1} H_{UL,2} . . . H_{UL,M}]^{T}, where T stands for the Transpose operation, ‘UL’ stands for uplink, and M is the number of antennas in base station. Let R_{UL} be the uplink channel covariance and thus the average uplink channel covariance is

$${R}_{UL} = \frac{1}{{N}_{e}} {\sum }_{i = 1}^{{N}_{e}} {{H}_{i , UL} ( {H}_{i , UL} )}^{H} ,$$

where Nₑ is the number of received signals ([1, ∞)) with the same direction of arrival (DOA) in the coherence time interval and ^{H} stands for Hermitian operation.

The term “coherence time interval” as used herein refers to a time interval within which the phase and magnitude of a communication channel are, on average, predictable, or highly correlated. Signals in any interval shorter than the coherence time interval can be averaged when considering communication channel conditions.

The process 100 begins at 105 when the BS 10 receives one or more uplink transmissions from the MS 20. Next, at 110, the BS 10 computes initial predicted beamforming weight vectors {wₙ}ₙ₌₁^{N}^{_{w}}. There are several methods by which the BS may compute the initial predicted beamforming weight vectors {wₙ}ₙ₌₁^{N}^{_{w}}. The computations made at 110 are without feedback information from the MS, i.e., the first time BS is to send beamformed streams to the MS.

The results of one or several of the methods described herein may be used to set the initial beamforming weight vectors used to generate the initial beamformed streams for downlink transmission. That is, the jth beamforming weight vector may be generated by any of the following methods. But the plurality of beamforming weight vectors may be selected based on the criteria that the correlation between different beamforming weight vectors is low.

One technique is to compute a beamforming weight vector w from a normalized average of the estimated uplink channel coefficients, as w= H̅_{UL}/norm( H̅_{UL}).

Another technique is to compute a beamforming weight vector w as the principle eigenvector of the average uplink channel covariance matrix R_{UL}, or the combination of eigenvectors of R_{UL}. For example, assume that the M eigenvectors of the average uplink channel covariance matrix R_{UL} are {U₁, U₂, . . . , U_{M}}. The beamforming weight w can be written as w=(c₁U₁+c₂U₂+ . . . +c_{M}U_{M})/norm(c₁U₁+c₂U₂+ . . . + . . .+c_{M}U_{M}), where {cⱼ}ⱼ₌₁^{M} are complex weighting values (some cⱼ could be set to zero).

Still another technique is as follows. For FDD systems, the estimated downlink covariance R_{DL} is computed from a transformation R_{DL}=R_{UL}C_{T}, where C_{T} is a constant (M by M) transformation matrix. The transformation matrix C_{T} is fixed based on system parameters (the number of antennas, the spacing of antennas, the number of sectors, uplink and downlink carrier frequencies, etc.). A beamforming weight vector w is computed as the principle eigenvector of the average downlink channel covariance matrix R_{DL}, or the combination of eigenvectors of R_{DL}. For example, assume that the M eigenvectors of average downlink channel covariance matrix R_{DL} are {V₁, V₂, . . . , V_{M}}. The beamforming weight vector w can be written as w=(d₁V₁+d₂V₂+ . . . +d_{M}V_{M})/norm(d₁V₁+d₂V₂+ . . . + d_{M}V_{M}), where {dⱼ}ⱼ₌₁^{M} are complex weighting values (dⱼ could be set to zero).

Yet another technique is as follows. A spatial subspace decomposition is applied to the uplink average channel covariance matrix in order to estimate the K maximum DOAs with angles {θ₁, θ₂, . . . θ_{K}}. The complex-valued projection of the K DOAs are p=[p₁, p₂, . . . p_{K}]. Spatial subspace decomposition means the space domain is divided into parts called subspaces. For example, when considering a two-dimensional (2D) space, subspace one (‘1’) is from 0 degree to 45 degrees, and subspace two (‘2’) is from 45 degrees to 90 degrees and subspace three (‘3’) is from 90 degrees to 180 degrees, etc. For a three-dimensional (3D) space, polarization may be used to divide space into parts. Also, the spatial subspace decomposition could be used on the vectors which describe the space domain. For example, when the number of antennas is M, the beamforming weight is 1×M vector, then there are M independent/orthogonal subspaces which are the bases of the linear composition of all 1×M vectors. The quantity A(O, A) is the array steering vector (or array response vector) for the DOA θ, and λ is uplink or downlink carrier wavelength (λ_{UL} or λ_{DL}). For example, for a uniform linear array (ULA),

$$A ( θ , λ ) = {[ \begin{matrix}1 & {e}^{j \frac{2 π D}{λ} sin ( θ )} & … & {e}^{j \frac{2 π D}{λ} ( M - 1 ) sin ( θ )}\end{matrix} ]}^{T} ,$$

where D is the distance between two adjacent antennas. For a uniform circular array (UCA),

$$A ( θ , λ ) = {[ \begin{matrix}{e}^{- j \frac{2 π r}{λ} cos ( θ )} & {e}^{- j \frac{2 π r}{λ} cos ( θ - \frac{2 π}{M} )} & … & {e}^{- j \frac{2 π r}{λ} cos ( θ - \frac{( M - 1 ) 2 π}{M} ) )}\end{matrix} ]}^{T} ,$$

where r is the radius of the circular array.

The initial predicted beamforming weight may be computed as w=f₁p₁A(θ₁, λ_{DL})+f₂p₂A(θ₂, λ_{DL})+ . . . +f_{K}p_{K}A(θ_{K}, λ_{DL}), or w=[f₁p₁ f₂p₂ . . . f_{K}p_{K}]pinv([A(θ₁, λ_{DL}) A(θ₂, λ_{DL}) . . . A(θ_{K}, λ_{DL})]), where {fₖ}ₖ₌₁^{K} are instances of a complex random variable ηe^{jβ}, η is a uniformly random variable with mean 1 and β is a uniformly random variable in the range or [0, 2 π] and pinv( ) is a pseudo-inverse operation.

Another technique for computing the initial predicted beamforming weight vectors is as follows. Based on the estimated average frequency domain uplink/downlink channel coefficients or estimated average uplink/downlink channel covariance matrix, the J maximum estimated channel taps in time domain may be computed as h=[h₁ h₂ . . . hⱼ] with the time delays τ=[τ₁ τ₂ . . . τ_{J}]. A beamforming weight vector for the frequency band y may be computed as w=g₁h₁ exp(j2πτ₁y)+g₂h₂ exp(j2πτ₂y)+ . . . +g_{J}h_{J} exp(j2πτ_{J}y), where {gₖ}ₖ₌₁^{J} are instances of a complex random variable ηe^{jβ}, η is a uniformly random variable with mean 1 and β is a uniformly random variable in the range or [0, 2 π].

Using any one or more of the techniques described above, a plurality of (initial) beamforming weight vectors {wₙ}ₙ₌₁^{N}^{_{w}} are computed at 110, where the total number of vectors is N_{w}. As mentioned above, one criteria that is useful to choose the N_{w} beamforming weights is that the correlation between different beamforming weight vectors, wₙ₁^{H}wₙ₂ for n1≢n2, is small. The number of beamforming weight vectors N_{w} does not necessarily equal the number M of real antennas at the BS. For example, the BS may have 8 antennas, but there may be 4 beamforming weight vectors (N_{w}=4). The beamformed stream that results from a corresponding one of the beamforming weight vectors at the BS side is referred to herein as a “virtual antenna”.

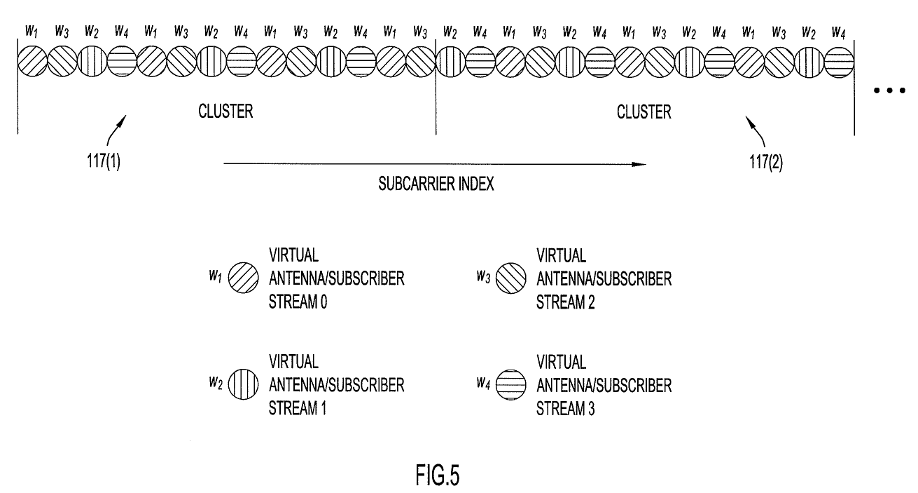

Next, at 115, a beamformed pilot/data stream is generated for each of the beamforming weight vectors N_{w}. For example, in the WiMax communication standard, there is a mid-amble that is useful for closed-loop processes. Using the mid-amble, 2, 3, 4, 7, or 14 beamformed streams may be generated. Referring to FIG. 5, an example is shown to illustrate how the beamformed streams are generated. In this example, a plurality of “clusters” are shown, each of which comprises a plurality of subcarriers. FIG. 5 illustrates an example of the signaling format in the partial usage of subcarrier (PUSC) mode in a WiMAX system. There is one OFDM symbol for a mid-amble. The mid-amble subcarrier set is computes as −(N_{used}/2)+n+Nₜp, where Nₜ is the number of transmit antennas at the BS, n is the antenna index, from 0 to Nt−1, and p is the subcarrier index. In the example shown in FIG. 5, there are four virtual antennas at the BS, i.e., n=0, 1, 2, and 3 or N_{w}=4. A different beamforming weight vector is applied to a plurality of subcarriers within a corresponding group (cluster). For example, beamforming weight vector w₁ is applied to the subcarriers associated with the pattern of subcarriers assigned to virtual antenna/subcarrier stream 0 to produce a first beamformed stream, beamforming weight vector w₂ is applied to the subcarriers associated with the pattern of subcarriers assigned to virtual antenna/subcarrier stream 1 to produce a second beamformed stream, beamforming weight vector w₃ is applied to the subcarriers associated with the pattern of subcarriers assigned to virtual antenna/subcarrier stream 2 and beamforming weight vector w₄ is applied to the subcarriers associated with the pattern of subcarriers assigned to virtual antenna/subcarrier stream 3. The subcarriers in a mid-amble are all pilot signals. In either case, each of the plurality of subcarriers assigned to a virtual antenna is weighted by a corresponding one of the plurality of beamforming weight vectors {wₙ}ₙ₌₁^{N}^{_{w}}. Thus, pilot signals are sent repeatedly from multiple antennas and with different weights, and as shown in FIG. 5, non-overlapping (in the frequency domain) subcarriers are allocated to the BS antennas. Thus, the N_{w} beamformed streams do not overlap in the frequency domain.

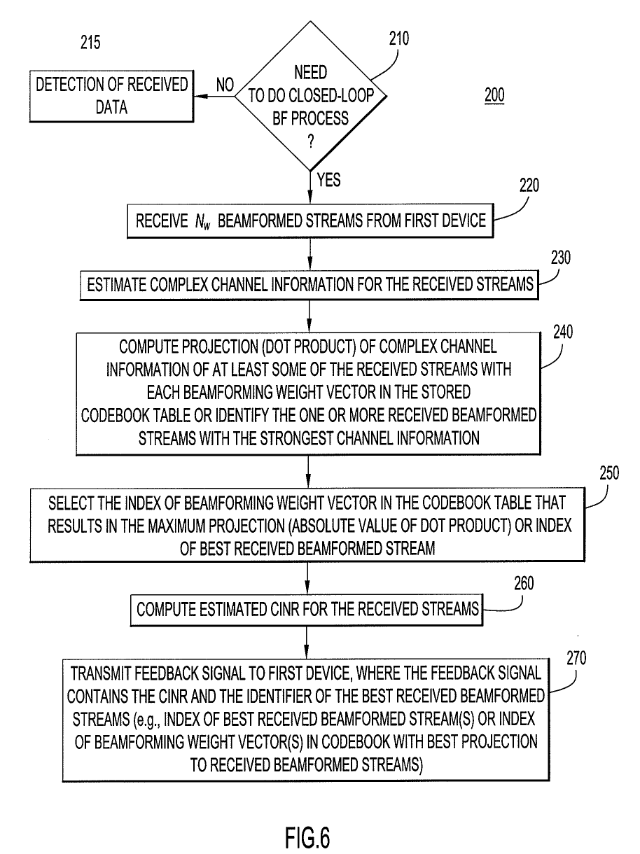

After the N_{w} beamformed streams are transmitted to the MS, the MS does some processing (described hereinafter in conjunction with FIG. 6), and at 120 the BS receives a feedback signal from the MS. The feedback signal contains a CINR report and an identifier of the best received beamformed stream or indices of several streams (among the N_{w} plurality of beamformed streams transmitted by the BS). For example, the identifier may comprise an index of the best received beamformed stream or indices of the best received beamformed stream (also referred to herein as an index or indices of the best or preferred virtual antennas). Or, the identifier may comprise an codebook index of the beamformed weight vector in the codebook that has the best projection to the received beamformed streams.

At 125, the BS compares the CINR contained in the feedback signal with a threshold. The threshold is set based on a variety of system parameters and reflects a minimum desired CINR. When the CINR exceeds the threshold, then at 135 the closed-loop process terminates and the BS uses the selected beamforming weight vectors for normal transmission modes to that MS. In general, BS uses one or two beamforming weight vectors for single-input single-output (SISO) or multiple-input multiple-output (MIMO) transmission.

When the CINR does not exceed the threshold, then at 130, a loop or iteration counter is compared with a maximum counter value. When the loop counter exceeds the maximum value, then the process continues to 135 where the closed-loop process terminates.

When the loop counter has not exceeded the maximum counter value, then the process continues to 140. At 140, the feedback type contained in the feedback signal is determined. If the identifier of the best received beamformed stream is an index of the received beamformed streams transmitted by the BS, then at 145, the first beamforming weight vector W_{1,new} in the set of new or updated N_{w} beamforming weight vectors is set equal to the beamforming weight vector associated with the best received beamformed stream. On the other hand, when the identifier of the best received beamformed stream is a codebook index of a beamforming weight vector that was determined by the MS to have the best projection to the received beamformed streams in the most recent iteration, then at 150, the first beamforming weight vector w_{1,new} in the set of new or updated N_{w} beamforming weight vectors is computed from the current N_{w} beamforming weight vectors as:

$${w}_{1 , new} = [ \begin{matrix}{w}_{i 1} & … & {w}_{iZ}\end{matrix} ] [ \begin{matrix}{\tilde{w}}_{selected , 1} \\ … \\ {\tilde{w}}_{selected , Z}\end{matrix} ]$$

where i1 to iZ are the indices of the virtual antennas of received signals which are applied to beamforming weights at the MS. Base on this aspect of the process reflected by this equation, the process can be said to employ “double beamforming”, and in so doing improving the performance of a closed loop beamforming method.

That is, the first new beamforming weight vector w_{1,new} is computed from the plurality of weight vectors at the prior iteration multiplied by the weights of the weight vector in the codebook whose index was contained in the feedback signal transmitted by the MS to the BS.

Some additional computation techniques may be employed at 155 when computing the remaining new predicted beamforming weight vectors from the first new beamforming weight vector w_{1,new}. One technique involves using the first new beamforming weight w_{1,new} and applying an adjustment vector Δ=[Δ₁ Δ₂ . . . Δ_{M}]^{T} to generate a new beamforming weight vector as w_{j,new}=(w_{1,new}+Δ)/norm(w_{1,new}+Δ), where Δ is an instance of random variable with mean 0. This is one technique for generating the remaining new predicted beamforming weight vectors from the first new beamforming weight vector w_{1,new}.

When the first new beamforming weight vector w_{1,new} is expressed as w_{1,new}=f₁p₁A(θ₁, λ_{ADL})+f₂p₂A(θ₂, λ_{DL})+ . . . +f_{K}p_{K}A(θ_{K}, λ_{DL}), or w_{1,new}=[f₁p₁ f₂p₂ . . . f_{K}p_{K}]pinv([A(θ₁, λ_{DL}) A(θ₂, λ_{DL}) . . . A(θ_{K}, λ_{DL})]), or w_{1,new}=g₁h₁ exp(j2πτ₁y)+g₂h₂ exp(j2πτ₂y)+ . . . +g_{J}h_{J} exp(j2πτ_{J}y), the parameters {fₖ}ₖ₌₁^{K} or {gₖ}ₖ₌₁^{J} can be adjusted as f_{k,new}=fₖ+Λₖ or g_{k,new}=gₖ+Λₖ, where Λₖ is an instance of a random variable with mean 0. Then, a new predicted beamforming weight vector can be computed as w_{j,new}=f_{1,new}p₁A(θ₁, λ_{DL})+f_{2,new}p₂A(θ₂, λ_{DL})+ . . . +f_{K,new}p_{K}A(θ_{K}, λ_{DL}), or w_{j,new}=[f_{1,new}p₁ f_{2,new}p₂ . . . f_{K,new}p_{K}]pinv([A(θ₁, λ_{DL}) A(θ₂, λ_{DL}) . . . A(θ_{K}, λ_{DL})]), or w_{j,new}=g_{1,new}h₁ exp(j2πτ₁y)+g_{2,new}h₂ exp(j2πτ₂y)+ . . . +g_{J,new}h_{J} exp(j2πτ_{J}y).

Also, the loop counter is incremented at 155. Furthermore, the techniques described above in conjunction with step 110 may be used to compute the remaining new predicted N_{w} beamforming weight vectors from the first new beamforming weight vector w_{1,new}. As before, the new predicted beamforming weight vectors may be computed under the constraint that the correlation between the respective new beamforming weight vectors is small.

After the new N_{w} beamforming weight vectors are computed, then the process continues to 115 where the BS generates the plurality of beamformed streams using the new N_{w} beamforming weight vectors, and the beamformed streams are transmitted to the MS.

Turning now to FIG. 6, the feedback process 200 performed at the MS is described. At 210, the MS determines whether it needs to perform its computations associated with the closed-loop process. For example, if the BS has already selected the best beamforming weight vector(s) for normal transmission modes to the MS, then the MS need not continue through its computations associated with the feedback process 200. Instead, at 215, the MS detects the received signals and recovers the data contained in the received signals as it would for normal receive modes. However, if at 210 it is determined that the MS needs to perform its computations associated with the closed-loop process, then at 220, the MS receives the N_{w} beamformed streams from the BS. At 230, the MS estimates the complex channel information for each received beamformed stream. The complex channel information may be represented by a set of vectors q=[q₁ q₂ . . . q_{Nw}].

At 240, the MS computes projections (dot product) of the complex channel information for the received streams with each beamforming weight vector in the stored codebook table, or the MS otherwise identifies the one or more received beamformed streams with the strongest channel information.

The beamforming weight vectors in the stored codebook are fixed and are known by BS based on the corresponding unique index. The dimension (or the number of elements) (Z) of beamforming weight vectors in the codebook may be less than the number N_{w} of beamformed streams. For example, there may be 1×2 beamforming weight vectors in the codebook table. Each of beamforming weight vectors \tilde{w}₁, \tilde{w}₂, . . . , \tilde{w}_{Ncodebook}, in the codebook table is applied to at least some (e.g., any two) of the received beamformed streams [q₁ q₂ . . . q_{Nw}] in order to compute the dot product of beamforming weight vector in the codebook with any two of the received beamformed stream. For example, in the case of the first beamforming weight vector \tilde{w}₁ in the codebook table, the dot product is computed by the computation conj(b_{j,1})qᵢ₁+conj(b_{j,2})qᵢ₂, where conj( ) is the conjugate operation. In general, using the channel information q=[q₁ q₂ . . . q_{NW}] for all of the Nw received beamformed streams, the computation is conj(b_{j,1})qᵢ₁+conj(b_{j,2})qᵢ₂+ . . . +conj(b_{j, Z})q_{iZ}, where i1, i2 to iZ are the selected index of virtual antennas, j is the index of beamforming weights vectors in the codebook at the MS, where j could be 1 to Z.

As mentioned above, rather that computing the projection of each of the beamformed streams with each of the beamforming weight vectors in the codebook, the MS may select the best received beamformed stream(s) that have/has the best channel information. For example, the MS may select the received beamformed stream whose channel information/response has the largest absolute value, i.e., arg max |qᵢ|.

At 250, the MS selects the index (or indices, if several) of the beamforming weight vector in the codebook that has the maximum projection to the received beamformed streams, or selects the index (or indices, if several) of the received beamformed streams that has the strongest channel information (best received beamformed stream).

At 260, the MS computes the CINR. Numerous techniques are known for computing the CINR, the details of which are not described herein. For example, one technique involves storing data for each received wireless transmission frame, wherein the stored data represents a first vector for received signals in active subcarriers of the frame. A preamble for the frame is detected and data is stored representing a second vector for a code in the active subcarriers. An estimate of a sum of signal power and interference-plus-noise power is computed from the first and second vectors, and an estimate of the signal power is computed from the first and second vectors. Thus, an estimate of the interference-plus-noise power is computed from the sum and from the estimate of the signal power. A CINR quantity is then computed from the estimate of the signal power and the estimate of the interference-plus-noise power. In another technique, wireless transmissions are received that include pilot signals in subcarriers. For each block of contiguous subcarriers in a symbol, data is stored representing the received pilot signals in subcarriers. An estimate of a sum of estimated signal power and estimated interference-plus-noise power is computed from the received pilot signals. A difference is computed between received pilot signals in adjacent subcarriers and symbols. An estimate of the interference-plus-noise power is computed from the difference and an estimate of the signal power is computed from the sum and from the estimate of the interference-plus-noise power. The CINIR quantity is then computed from the estimate of the signal power and the estimate of the interference-plus-noise power.

At 270, the MS transmits a feedback signal to BS. The feedback signal contains the CINR computed at 260, together with the identifier(s) of the best received beamformed stream(s) (e.g., index or indices of the best received beamformed stream(s)) or the identifier(s) (index or indices) of the beamforming weight vector(s) in the codebook with best projection to received beamformed streams.

The BS receives the feedback signal and uses the information contained therein as described above at 120-155 in FIG. 4. As mentioned above, the closed-loop process repeats until the BS determines that the CINR threshold is met or until the loop counter reaches a maximum value.

Although the apparatus, system, and method are illustrated and described herein as embodied in one or more specific examples, it is nevertheless not intended to be limited to the details shown, since various modifications and structural changes may be made therein without departing from the scope of the apparatus, system, and method and within the scope and range of equivalents of the claims. Accordingly, it is appropriate that the appended claims be construed broadly and in a manner consistent with the scope of the apparatus, system, and method, as set forth in the following claims.

What is claimed is:

1. A method comprising:
at a first device, applying respective ones of a plurality of beamforming weight vectors to subcarriers associated with a pattern of subcarriers assigned to a corresponding stream such that the plurality of subcarriers assigned to a stream is weighted by a corresponding one of the plurality of beamforming weight vectors to produce a plurality of beamformed streams;
transmitting the plurality of beamformed streams from a plurality of antennas of the first device to a second device;
receiving at the second device the plurality of beamformed streams transmitted from the first device;
at the second device, estimating channel information for each of the plurality of beamformed streams received from the first device;
analyzing the channel information to identify at least one of the beamformed streams that is preferred over the others based on its channel information;
transmitting from the second device to the first device a signal that contains information identifying the preferred beamformed stream; and
at the first device, receiving the signal that contains information identifying the preferred beamformed stream, computing a plurality of new beamforming weight vectors based on the information identifying the preferred beamformed stream and repeating said applying and transmitting using the plurality of new beamforming weight vectors.

2. The method of claim 1, and further comprising:
receiving at the plurality of antennas of the first device a transmission from a second device;
computing a plurality of initial beamforming weight vectors from the received transmission; and
performing said applying and transmitting at the first device using the plurality of initial beamforming weight vectors.

3. The method of claim 1, and further comprising storing at the first device and the second device a codebook comprising values for a plurality of beamforming weight vectors, and wherein analyzing comprises computing a projection of the channel information for at least some of the received beamformed streams to each of the beamforming weight vectors in the codebook and wherein the information identifying the preferred beamformed stream comprises an index of a beamforming weight vector in the codebook that is determined to have the maximum projection to the channel information for at least some of the received beamformed streams.

4. The method of claim 3, wherein computing the plurality of new beamforming weight vectors comprises generating a first new beamforming weight vector of the plurality of new beamforming weight vectors using the beamforming weight vector in the codebook corresponding to the index contained in the signal received from the second device, and computing a plurality of remaining new beamforming weight vectors from the first new beamforming weight vector.

5. The method of claim 3, and further comprising computing a carrier to interference plus noise ratio at the second device based on the plurality of beamformed streams received at the second device, and including the carrier to interference plus noise ratio in the signal that is transmitted from the second device to the first device.

6. The method of claim 5, and further comprising at the first device comparing the carrier to interference plus noise ratio with a threshold, and terminating any further computing of new beamforming weight vectors when the carrier to interference plus noise ratio exceeds the threshold.

7. The method of claim 1, wherein analyzing comprises selecting the received beamforming stream whose channel information has the that has the largest absolute value as the preferred beamformed stream.

8. An apparatus comprising:
a plurality of antennas;
a receiver that is configured to received signals detected by respective ones of the plurality of antennas;
a transmitter that is configured to transmit signals via respective ones of the plurality of antennas;
a controller that is coupled to the transmitter and receiver, wherein the controller is configured to:
apply respective ones of a plurality of beamforming weight vectors to subcarriers associated with a pattern of subcarriers assigned to a corresponding stream such that the plurality of subcarriers assigned to a stream is weighted by a corresponding one of the plurality of beamforming weight vectors to produce a plurality of beamformed streams;
supply the plurality of beamformed streams to the transmitter for transmission via the plurality of antennas to a second device; and
analyze information contained in a feedback signal received from the second device, wherein the information includes an identifier of a preferred one of the plurality of beamformed streams received by the second device, in order to compute a plurality of new beamforming weight vectors based on the identifier of the preferred beamformed stream, wherein the apply and supply functions of the controller are repeated using the plurality of new beamforming weight vectors.

9. The apparatus of claim 8, and further comprising a memory that stores a codebook containing values for a plurality of beamforming weight vectors, and the identifier comprises an index corresponding to one of the plurality of beamforming weight vectors, and wherein the controller is configured to match the index contained in the feedback signal with the corresponding beamforming weight vector in the stored codebook that was used to produce the beamformed stream which the second device identified as the preferred beamformed stream.

10. The apparatus of claim 9, wherein the controller is configured to compute the plurality of new beamforming weight vectors using as a first new beamforming weight vector of the plurality of new beamforming weight vectors the beamforming weight vector in the codebook corresponding to the index contained in the feedback signal received from the second device, and to compute a plurality of remaining new beamforming weight vectors from the first new beamforming weight vector.

11. The apparatus of claim 8, wherein the controller is configured to compare a carrier to interference plus noise ratio contained in the feedback signal received from the second device with a threshold, and to terminate any further computing of new beamforming weight vectors when the carrier to interference plus noise ratio exceeds the threshold.

12. Logic encoded in one or more tangible media for execution and when executed operable to:
apply respective ones of a plurality of beamforming weight vectors to subcarriers associated with a pattern of subcarriers assigned to a corresponding stream such that the plurality of subcarriers assigned to a stream is weighted by a corresponding one of the plurality of beamforming weight vectors to produce a plurality of beamformed streams;
supply the plurality of beamformed streams to the transmitter for transmission via a plurality of antennas of first device to a second device; and
analyze information contained in a feedback signal received from the second device, wherein the information includes an identifier of a preferred one of the plurality of beamformed streams received by the second device, in order to compute a plurality of new beamforming weight vectors based on the identifier of the preferred beamformed stream, wherein the apply and supply functions of the controller are repeated using the plurality of new beamforming weight vectors.

13. The logic of claim 12, and further comprising logic that stores at the first device a codebook containing values for a plurality of beamforming weight vectors each of which has a corresponding assigned index in the codebook, and wherein the identifier comprises an index corresponding to one of the plurality of beamforming weight vectors, and wherein the logic to analyze is configured to match the index contained in the feedback signal with the corresponding beamforming weight vector in the stored codebook that was used to produce the beamformed stream which the second device identified as the preferred beamformed stream.

14. The logic of claim 13, wherein the logic that analyzes comprises logic configured to compute the plurality of new beamforming weight vectors using as a first new beamforming weight vector of the plurality of new beamforming weight vectors the beamforming weight vector in the codebook corresponding to the index contained in the feedback signal received from the second device, and to compute a plurality of remaining new beamforming weight vectors from the first new beamforming weight vector.

15. The logic of claim 12, and further comprising logic to compare a carrier to interference plus noise ratio contained in the feedback signal received from the second device with a threshold, and to terminate any further computing of new beamforming weight vectors when the carrier to interference plus noise ratio exceeds the threshold.

16. A method comprising:
receiving at a second device a plurality of beamformed streams transmitted via a plurality of antennas of a first device, wherein the plurality of beamformed streams are produced by applying respective ones of a plurality of beamforming weight vectors to subcarriers associated with a pattern of subcarriers assigned to a corresponding stream such that the plurality of subcarriers assigned to a stream is weighted by a corresponding one of the plurality of beamforming weight vectors;
estimating channel information for the plurality of beamformed streams;
analyzing the channel information to identify at least one of the beamformed streams that is preferred over the others based on its channel information;
transmitting from the second device to the first device a feedback signal that contains information identifying the preferred beamformed stream.

17. The method of claim 16, and further comprising storing a codebook comprising values for a plurality of beamforming weight vectors, and wherein analyzing comprises computing a projection of the channel information for at least some of the received beamformed streams to each of the beamforming weight vectors in the codebook and wherein the information identifying the preferred beamformed stream comprises an index of a beamforming weight vector in the codebook that is determined to have the maximum projection to the channel information for at least some of the received beamformed streams.

18. The method of claim 16, and further comprising computing a carrier to interference plus noise ratio at the second device based on the plurality of beamformed streams received at the second device, and including the carrier to interference plus noise ratio in the feedback signal.

19. The method of claim 16, wherein analyzing comprises selecting the received beamforming stream whose channel information that has the largest absolute value as the preferred beamformed stream.

20. Logic encoded in one or more tangible media for execution and when executed operable to:
estimate channel information for a plurality of beamformed streams received at a second device and transmitted via a plurality of antennas of a first device, wherein the plurality of beamformed streams are produced by applying respective ones of a plurality of beamforming weight vectors to subcarriers associated with a pattern of subcarriers assigned to a corresponding stream such that the plurality of subcarriers assigned to a stream is weighted by a corresponding one of the plurality of beamforming weight vectors;
analyze the channel information to identify at least one of the beamformed streams that is preferred over the others based on its channel information;
transmit from the second device to the first device a feedback signal that contains information identifying the preferred beamformed stream.

21. The logic of claim 20, and further comprising logic that stores a codebook comprising values for a plurality of beamforming weight vectors, and wherein the logic that analyzes is configured to compute a projection of the channel information for at least some of the received beamformed streams to each of the beamforming weight vectors in the codebook and wherein the information identifying the preferred beamformed stream comprises an index of a beamforming weight vector in the codebook that is determined to have the maximum projection to the channel information for at least some of the received beamformed streams.

22. The logic of claim 20, and further comprising logic that is configured to compute a carrier to interference plus noise ratio at the second device based on the plurality of beamformed streams received at the second device, and to include the carrier to interference plus noise ratio in the feedback signal.

23. The logic of claim 20, wherein the logic that analyzes is configured to select the received beamforming stream whose channel information that has the largest absolute value as the preferred beamformed stream.
